(19) United States
(12) Patent Application Publication
(10) Pub. No.: US 2009/0118763 A1
(43) Pub. Date: May 7, 2009

(54) Infant soother slip sleeve

(76) Inventor: Danielle T. Abramson, Montville, NJ (US)

Correspondence Address: Danlell T. Abramson, 71 Eugene Dr., Montville, NJ, 07045, US

(21) Appl. No.: 11/982,643

(22) Filed: Nov. 2, 2007

(51) Int. Cl. A61J 17/00

(52) U.S. Cl. 606/235

(57) ABSTRACT

Infant soothers for providing stimulation to an infant are disclosed herein. According to aspects illustrated herein, there is provided an infant soother for placement over at least a portion of a tube. The infant soother includes a slip sleeve having a body with a first end, a second open end, and a longitudinal axis therebetween, wherein the slip sleeve has an outside surface that includes a teething surface.

### RELATED APPLICATIONS

None.

### FIELD

The embodiments disclosed herein relate to devices for soothing infants, and more particularly to slip sleeves that fit over at least a portion of a tube for providing stimulation to an infant.

### BACKGROUND

Changing a squirmy baby's diaper is a difficult task. Once a baby becomes mobile, they quickly realize that they do not like to be in one place for too long. Caregivers typically complain about diaper changes because every single diaper change is an exhausting battle Often, caregivers try to soothe or calm the baby by offering them something to hold during a diaper change. Usually, the easiest thing to grab is something carried in the diaper bag, such as a rattle or toy. Sometimes however, the caregiver does not have a toy to offer the baby, and once again the battle begins.

Most diaper bags these days are equipped with the necessary products: diapers, diaper rash cream, wipes and a change of clothes. Caregivers often will grab something in the diaper bag to keep the baby happy, for example, the diaper rash cream tube. The baby will usually hold the tube, chew or suck on the ends or side, and be entertained for the remainder of the diaper change. Although the sides or ends of the tube may satisfy the baby, it is often not desirable for the baby to put the ointment tube in the baby's mouth, for example, the edges could be sharp. Therefore, there remains a need to better entertain a baby during a diaper change.

### SUMMARY

Infant soothers for providing stimulation to an infant are disclosed herein. According to aspects illustrated herein, there is provided an infant soother for placement over at least a portion of a tube. The infant soother includes a slip sleeve having a body with a first end, a second open end, and a longitudinal axis therebetween, wherein the slip sleeve has an outside surface that includes a teething surface.

According to aspects illustrated herein, there is provided an infant soother for placement over at least a portion of a tube that includes a slip sleeve having a body with a first end, a second open end, and a longitudinal axis therebetween, wherein the slip sleeve has an outer surface that includes a soft surface.

According to aspects illustrated herein, there is provided an infant soother slip sleeve that includes a tubular body having a first end, a second open end, and a longitudinal axis therebetween; an outer surface that includes a textured teething surface; and an inner surface for engaging a tube, wherein the infant soother slip sleeve is placed over at least a portion of the tube and provides stimulation to an infant.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1A, FIG. 1B and FIG. 1C illustrate perspective views of infant soother slip sleeves of the presently disclosed embodiments. FIG. 1A illustrates a perspective view of an infant soother slip sleeve having a textured teething surface. FIG. 1B illustrates a perspective view of an infant soother slip sleeve having a soft surface with tactile and visual stimulation. FIG. 1C illustrates a perspective view of an infant soother slip sleeve having both a textured teething surface and a soft surface with tactile and visual stimulation.

FIG. 2 illustrates a perspective view of a tube having an infant soother slip sleeve of the presently disclosed embodiments.

FIG. 3 illustrates a front view of a tube having an infant soother slip sleeve of the presently disclosed embodiments.

While the above-identified drawings set forth presently disclosed embodiments, other embodiments are also contemplated, as noted in the discussion. This disclosure presents illustrative embodiments by way of representation and not limitation. Numerous other modifications and embodiments may be devised by those skilled in the art which fall within the scope and spirit of the principles of the presently disclosed embodiments.

### DETAILED DESCRIPTION

Infant soother slip sleeves are disclosed herein that fit over at least a portion of a tube, for example a diaper rash cream tube, and provide stimulation to an infant. The infant soother slip sleeves of the presently disclosed embodiments may be formed from a single material, or from a plurality of materials. The infant soother slip sleeves are designed for easy placement over at least a portion of a tube and removal from the tube. The infant soother slip sleeves may be designed to fit over the entire tube or a portion of the tube.

As used herein, the term “stimulation” refers to a feeling of pleasure when looked at, smelled, heard, or inserted into an infant's mouth.

As used herein, the terms “infant”, “baby” and “child” are used interchangeably.

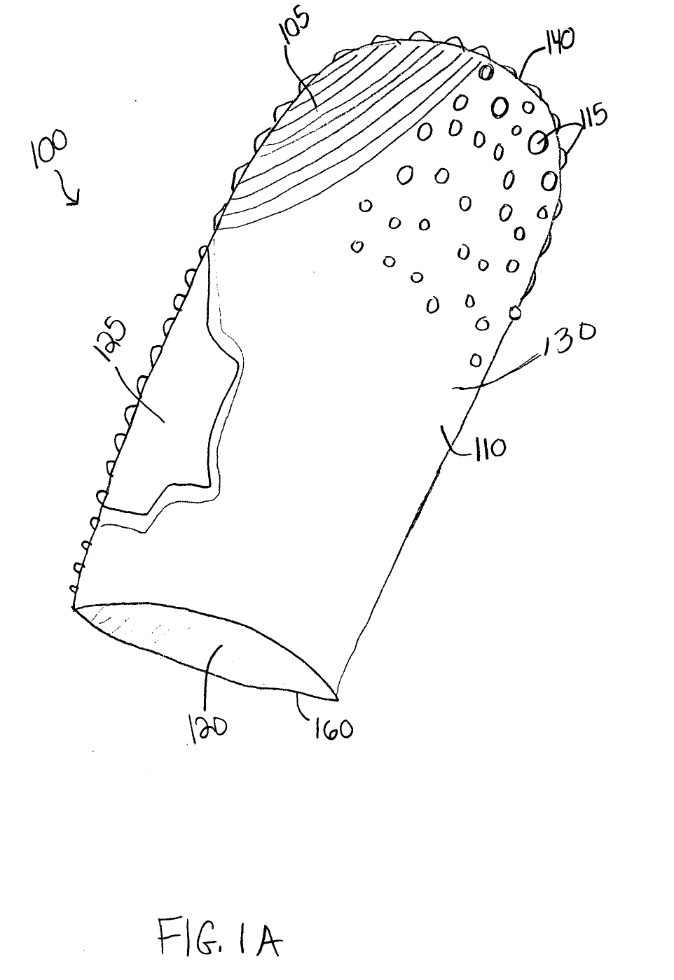

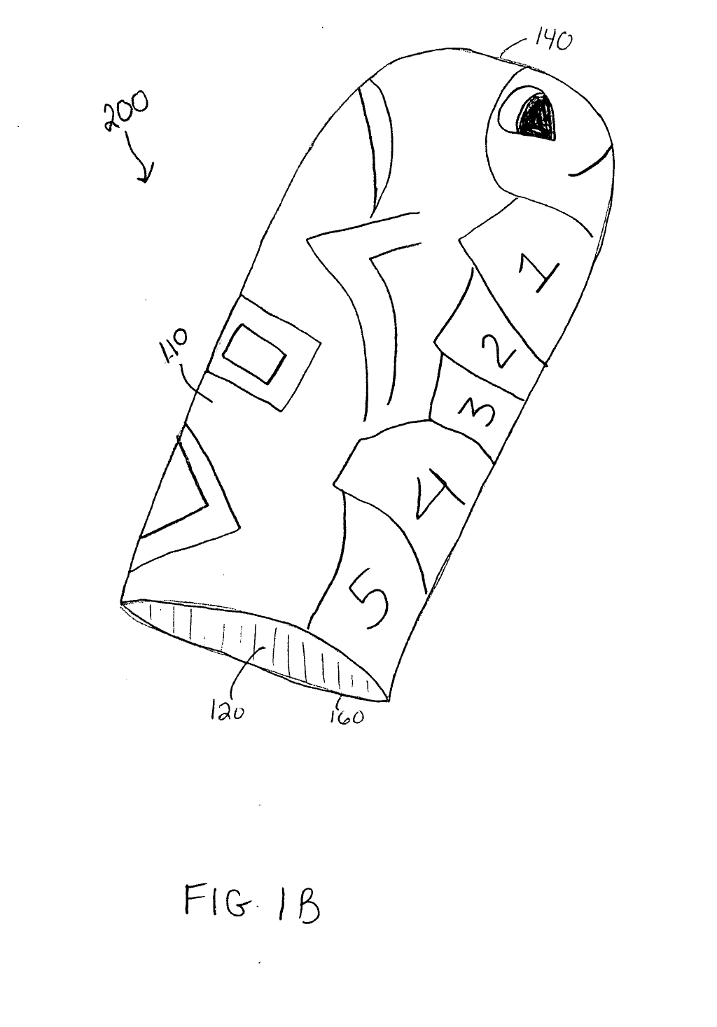

Infant soother slip sleeves of the presently disclosed embodiments are shown generally in FIG. 1A, FIG. 1B and FIG. 1C. Referring to FIG. 1A, an infant soother slip sleeve 100 includes a body 130 with a first end 140, a second open end 160, for insertion over a tube, and a vertical axis therebetween. The infant soother slip sleeve 100 has an outer surface 110 and an inner surface 120 for engaging the tube. The outer surface 110 may include a teething surface, a soft surface, or a combination. In the embodiment shown in FIG. 1A, the outer surface 110 includes a teething surface. Teething surface is meant to be interpreted broadly to include all elements made from a non-toxic material, sized and dimensioned to be comfortably inserted and partially retained in an infant's mouth for teething purposes. In an embodiment, the teething surface is a non-smooth textured surface, which is desirable for gum stimulation. The textured teething surface may include ribs 105, bumps 115 and/or depressions 125.

The teething surface may be fabricated from a non-allergenic, nontoxic, material that has a soft texture. In an embodiment, the teething surface is formed from a plastic or rubber material including, but not limited to, ethylene-vinyl acetate (EVA), tetrafluoroethylene (TFE), polyvinyl chloride (PVC), etc. The material of the teething surface may be transparent, semi-transparent, opaque, dyed, and/or the like. Suitable materials for these purposes are well known and are not part of the presently disclosed embodiments. In an embodiment, the infant soother slip sleeve having a teething surface may be refrigerated to provide cold stimulation to a teething baby.

Referring to FIG. 1B, an infant soother slip sleeve 200 has an outer surface 110 that includes a soft surface. The soft surface may contain a design and/or color theme that is aesthetically pleasing to an infant. The soft surface may be made from a material including, but not limited to, felt, velour, terrycloth, cloth, polyester fiber, polyurethane foam, and cellophane paper. The soft surface may be designed to include tactile stimulation, visual stimulation, and auditory stimulation. Tactile stimulation is meant to include an object having different textures and different shapes. For example, in the embodiment shown in FIG. 1B, the numbers may be embroidered and made from various textured materials. The infant soother slip sleeves of the presently disclosed embodiments may also include a fragrance, such as a vanilla scent. Visual stimulation is meant to include an object having different contrasts, different colors, and different shapes. For example, in the embodiment shown in FIG. 1B, the numbers may all be made from materials with different colors, for example, the colors of the rainbow, “1” is red; “2” is orange; “3” is yellow′ “4” is green; and “5” is blue. There may be various patterns and shapes such as squares and triangles that are made from bright, bold colors. The bright, bold colors may be used in combination with black lines or section that break up the color patterns. Auditory stimulation is meant to include bells, beads, chimes and squeezable noisy parts.

FIG. 1C shows an alternate embodiment of an infant soother slip sleeve 300 that includes both a textured surface and a soft surface. The first end 140 of the infant soother slip sleeve 300 may be any shape and still be within the scope and spirit of the presently disclosed embodiments. For example, in the embodiment shown in FIG. 1C, the first end 140 has been shaped to resemble a head of an animal. Those skilled in the art will recognize that the infant soother slip sleeves of the presently disclosed embodiments may include both a soft surface and a textured surface or another surface for providing stimulation to an infant. The various infant soother slip sleeves of the presently disclosed embodiments have been shown to include a body with a first end, a second open end, and a longitudinal axis therebetween. It is envisioned that there may be cutouts or holes anywhere along the body and still be within the scope and spirit of the presently disclosed embodiments.

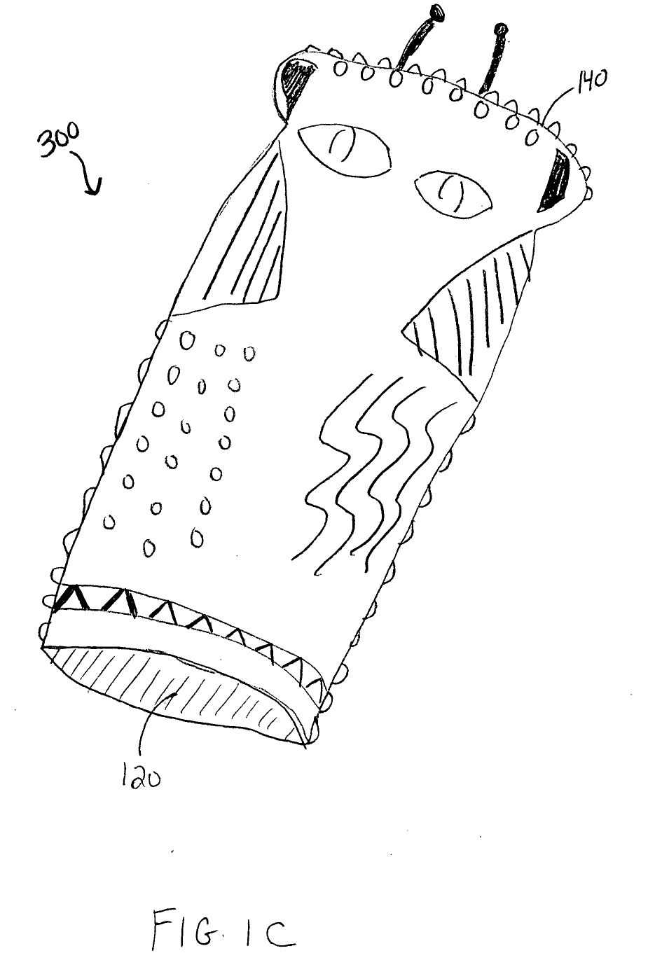

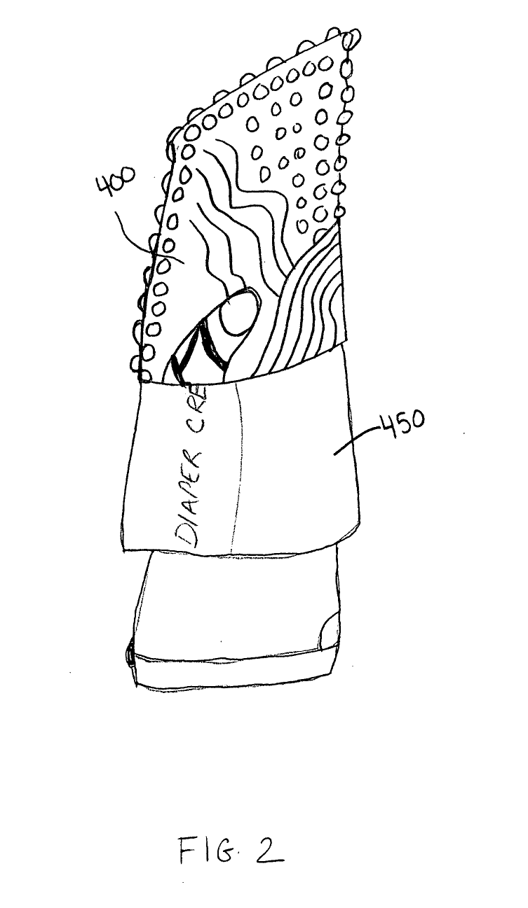

FIG. 2 is a perspective view showing an infant soother slip sleeve 400 of the presently disclosed embodiments over a portion of a diaper rash cream tube 450. The infant soother slip sleeve 400 fits snugly over the tube such that an infant will not be able to take the infant soother slip sleeve 400 off of the tube. The infant soother slip sleeve 400 shown in FIG. 2 has a textured outer surface 140.

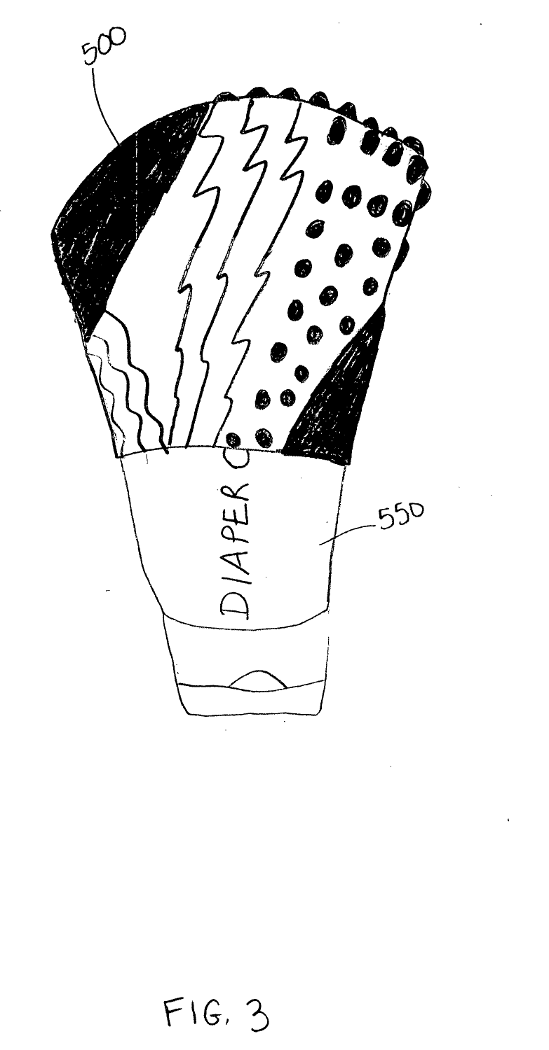

FIG. 3 is a front view showing an infant soother slip sleeve 500 of the presently disclosed embodiments on a tube 550, such as a diaper cream tube.

All patents, patent applications, and published references cited herein are hereby incorporated by reference in their entirety. It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An infant soother for placement over at least a portion of a tube comprising a slip sleeve having a body with a first end, a second open end, and a longitudinal axis therebetween, wherein the slip sleeve has an outside surface that includes a teething surface.

2. The infant soother of claim 1 wherein the teething surface is a non-smooth textured surface which provides gum stimulation.

3. The infant soother of claim 2 wherein the textured teething surface includes at least one of a rib, a bump and a depression on the outer surface.

4. The infant soother of claim 1 wherein the teething surface is fabricated from a non-allergenic, nontoxic material.

5. The infant soother of claim 1 wherein the teething surface is formed from a plastic or rubber material selected from the group consisting of ethylene-vinyl acetate (EVA), tetrafluoroethylene (TFE), and polyvinyl chloride (PVC).

6. The infant soother of claim 1 wherein the teething surface is fabricated from a transparent material.

7. The infant soother of claim 1 wherein the teething surface is fabricated from an opaque material.

8. The infant soother of claim 1 wherein the tube is a diaper rash cream tube.

9. The infant soother of claim 1 wherein the tube further includes a soft surface having at least one of a tactile stimulation, a visual stimulation and an auditory stimulation.

10. An infant soother for placement over at least a portion of a tube comprising a slip sleeve having a body with a first end, a second open end, and a longitudinal axis therebetween, wherein the slip sleeve has an outer surface that includes a soft surface.

11. The infant soother of claim 10 wherein the soft surface is fabricated from a material selected from the group consisting of felt, velour, terrycloth, cloth, polyester fiber, polyurethane foam, and cellophane paper.

12. The infant soother of claim 10 wherein the soft surface is designed to include tactile stimulation.

13. The infant soother of claim 12 wherein the tactile stimulation provides different textures.

14. The infant soother of claim 13 wherein the tactile stimulation is a textured teething surface.

15. The infant soother of claim 10 wherein the soft surface is designed to include visual stimulation.

16. The infant soother of claim 15 wherein the visual stimulation includes objects having different contrasts, different colors, and different shapes.

17. The infant soother of claim 10 wherein the soft surface is designed to include auditory stimulation.

18. The infant soother of claim 17 wherein the auditory stimulation includes objects with squeezable parts.

19. An infant soother slip sleeve comprising:
a tubular body having a first end, a second open end, and a longitudinal axis therebetween;
an outer surface that includes a textured teething surface; and
an inner surface for engaging a tube,
wherein the infant soother slip sleeve is placed over at least a portion of the tube and provides stimulation to an infant.

20. The infant soother slip sleeve of claim 19 wherein the tubular body is made from a non-allergenic, nontoxic material.
